(19) United States
(12) Patent Application Publication
(10) Pub. No.: US 2012/0158806 A1
(43) Pub. Date: Jun. 21, 2012

(54) PROVISIONING NETWORK-ATTACHED STORAGE

(75) Inventors: Richard A. Snyder, Columbia, MD (US); Emily Katherine Witt, Carver, MN (US)

(73) Assignee: VERIZON PATENT AND LICENSING INC., Basking Ridge, NJ (US)

(21) Appl. No.: 12/972,748

(22) Filed: Dec. 20, 2010

(51) Int. Cl. G06F 15/177; G06F 9/455; G06F 9/46; G06F 17/30

(52) U.S. Cl. 707/827; 709/222; 718/1; 718/102; 707/E17.01

(57) ABSTRACT

A system may receive a user request for provisioning a network attached storage over a network, provision a server with a domain name in response to the user request, configure the server with a user identifier and a password, for gaining authorized access to the server, create a logical volume, mounting the logical volume on the server, and export the logical volume as a shared volume.

### BACKGROUND INFORMATION

An in-house system developer may sometimes purchase and stage devices to build a system. When purchasing the devices, the system developer may evaluate device specifications, price, and/or equipment compatibility in light of particular project requirements. When staging the devices, the system developer may install operating systems, applications, databases and web servers, may apply patches, and/or may configure the devices.

### BRIEF DESCRIPTION OF THE DRAWINGS

FIG. 1 is a diagram illustrating an exemplary network in which concepts described herein may be implemented;

FIG. 2 is a block diagram of an exemplary network device shown in FIG. 1;

FIG. 3 is a block diagram illustrating exemplary functional components of the network devices shown in FIG. 2;

FIG. 4 illustrates interaction between a user device, VMM control device, hypervisor group, and storage device of FIG. 1 for provisioning and/or managing network attached storage (NAS) appliances;

FIG. 5 shows provisioning an exemplary NAS appliance via a virtual machine;

FIG. 6 is a list of exemplary resources and functions that one or more devices of FIG. 1 may support for provisioning resources;

FIG. 7 is a list of exemplary functions that one or more devices of FIG. 1 may support for provisioning NAS appliances;

FIG. 8 illustrates a view of an exemplary web-based user interface associated with provisioning a NAS appliance;

FIG. 9 is a flow diagram of an exemplary process that is associated with provisioning a NAS appliance; and

FIG. 10 is a flow diagram of an exemplary process that is associated with de-provisioning a NAS appliance.

### DETAILED DESCRIPTION OF PREFERRED EMBODIMENTS

The following detailed description refers to the accompanying drawings. The same reference numbers in different drawings may identify the same or similar elements.

As described below, a system may provision both virtual resources and physical resources. When a user wishes to obtain computing resources (e.g., a network, a server, an application, a web server, storage space, etc.), the user may connect to an integrated provisioning system via a web portal. Once connected via a web interface, the user may input parameters that describe the desired resources. Based on the parameters, the integrated resource provisioning system may provision and allocate virtual and/or physical resources with or without manual intervention from a system administrator or an operator.

In some implementations, the integrated resource provisioning system may provision a network attached storage (NAS) appliance via a virtual machine/physical device. In provisioning the NAS appliance, the system may receive one or more parameters from a user, provision a virtual machine/physical device, and provision the NAS appliances mounted on the virtual machine/physical device. Upon provisioning of the NAS appliance, the user may mount the NAS appliance on one or more virtual/physical hosts and use the NAS appliance for storage.

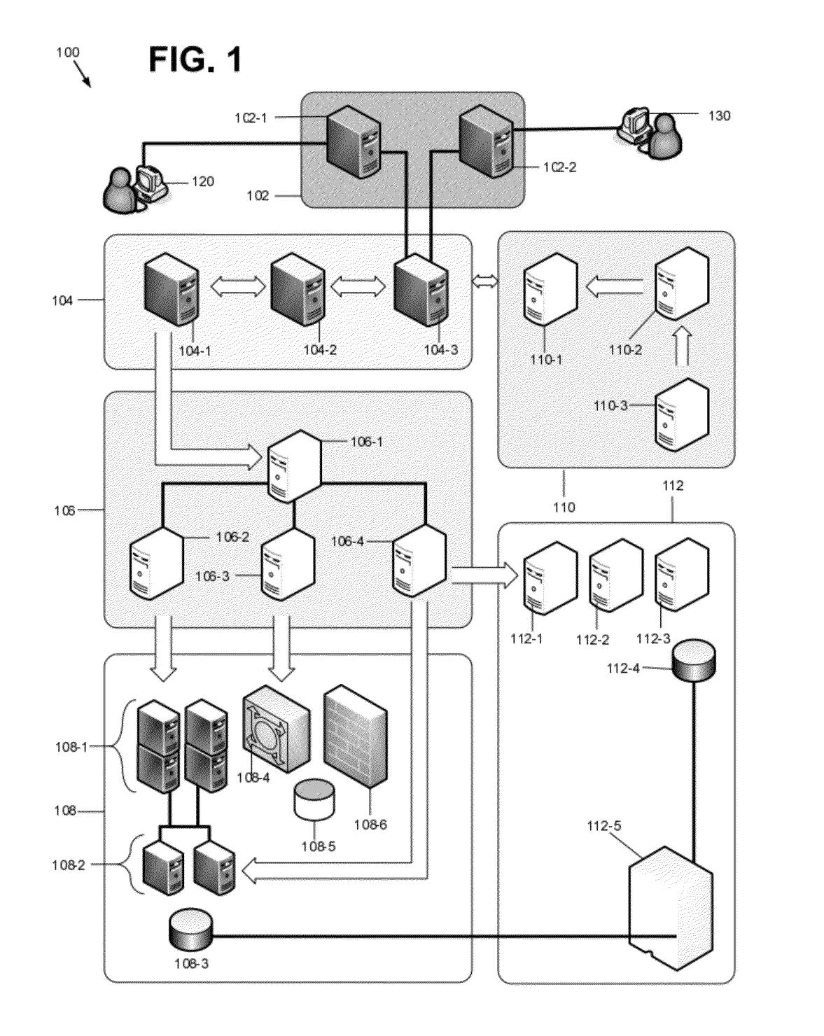

FIG. 1 is a diagram illustrating an exemplary network in which concepts described herein may be implemented. In one implementation, network 100 may include one or more wired and/or wireless networks that are capable of exchanging information, such as voice, video, data, multimedia information, text, etc. For example, network 100 may include one or more public switched telephone networks (PSTNs) or another type of switched network. Network 100 may also include one or more wireless networks and may include a number of transmission towers for receiving wireless signals and relaying the received signals toward the intended destination. Network 100 may further include one or more packet switched networks, such as an Internet Protocol (IP) based network, a local area network (LAN), a wide area network (WAN), a personal area network (PAN), an intranet, the Internet, or another type of network that is capable of exchanging information.

As shown, network 100 may include a presentation network 102, resource management network 104, workflow network 106, virtual system network 108, inventory management network 110, and physical resource network 112. For simplicity, network 100 of FIG. 1 does not show other networks or network components, such as bridges, routers, switches, wireless devices, etc. Depending on the implementation, network 100 may include additional, fewer, or different networks and/or network components.

Presentation network 102 may include devices that interact with users and system administrators. As further shown in FIG. 1, presentation network 102 may include an administrator portal device 102-1 and a user portal device 102-2. Administrator portal device 102-1 may interact with and relay information between a system administrator device, shown as item 120, and resource management network 104. Through the interaction, system administrator device 120 may perform system/network administration tasks (e.g., managing user accounts, performing an action that a user is not authorized to perform, managing a resource such as a NAS appliance, etc.).

User portal device 102-2 may interact with and relay information between a user device, illustrated as item 130, and resource management network 104. User device 130 may access provisioning services that are available via user portal device 102-2. For example, user device 130 may request resource management network 104 to provision or create a NAS appliance that is mounted on a virtual machine or a physical device.

Resource management network 104 may provide provisioning services and information pertaining to resources in networks 102-112. In providing the provisioning services/the information, resource management network 104 may track pools of resources that are available to user device 130, reserve a portion of the resources based on a request from user device 130, and allocate and configure the reserved resources for a user at user device 130. In addition, resource management network 104 may de-allocate the resources (e.g., return the portion to the pool) when user device 130 indicates that the user does not need the resources. In addition, resource management network 104 may provide support for administrative tasks (e.g., administer users perform resource allocation tasks that a user is not authorized to perform, etc.). The services that resource management network 104 provides may be associated with, for example, provisioning a network attached storage, a virtual/physical server, etc.

As further shown in FIG. 1, resource management network 104 may include a job database device 104-1, resource manager database 104-2, and resource management device 104-3. Job database device 104-1 may receive a job description (e.g., a list of tasks) from resource management device 104-3 and store it in an active job queue until the job is performed. Resource manager database 104-2 may store and/or retrieve configuration/usage data pertaining to a particular user and/or other bookkeeping information.

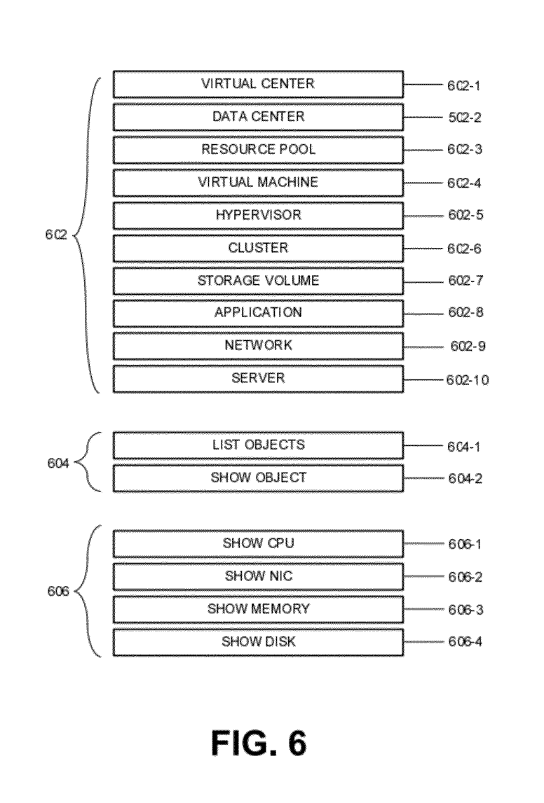

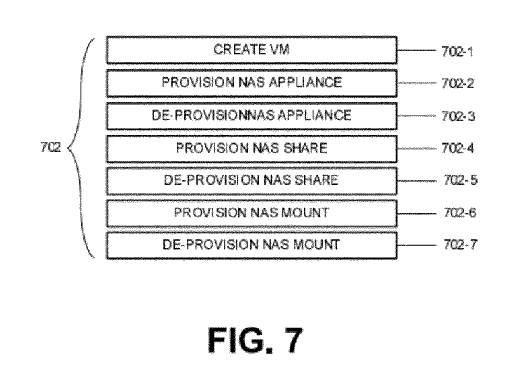

Resource management device 104-3 may receive requests for services from administrator/user device 120/130 via portal devices 102-1 and 102-2, and render the requested services. In rendering the services, resource management device 104-3 may execute functions that are listed in FIG. 6 and/or FIG. 7.

The services that resource management device 104-3 renders may include provisioning/de-provisioning resources based on inventory information provided by inventory management network 110. To provision/de-provision the resources (e.g., NAS appliance), resource management device 104-3 may create a description of a job based on: user input relayed by user portal device 102-2, user configuration, and/or available resources. Resource management device 104-3 may handoff the job description to job database device 104-1, to be placed in the active job queue. In some implementations, resource management device 104-3 may provision multiple servers, NAS appliances, allocate Internet Protocol (IP) addresses to the servers, provision a storage space shared by the servers, provision a domain name system (DNS) name, and create a cluster from the servers.

In providing the services, resource management device 104-3 may manage resource objects that correspond to physical or virtual resources in networks 102-112. Thus, for example, when user device 130 requests information relating to a physical server, via user portal device 102-2, resource management device 104-3 may provide user device 130 with information from the resource object representing the physical server. Resource management device 104-3 may receive data for instantiating the resource objects from one or more databases in networks 102-112 (e.g., a database in network 110).

Workflow network 106 may perform jobs whose descriptions are in the active job queue at job database device 104-1. Once the job is performed, workflow network 106 may instruct job database device 104-1 to de-queue the job description (e.g., provisioning a server, creating a cluster, etc.). As further shown in FIG. 1, workflow network 106 may include a workflow engine device 106-1, virtual machine management (VMM) control device 106-2, network management device 106-3, and resource lifecycle management device 106-4.

Workflow engine device 106-1 may perform subtasks of a job as defined by a job description in the active job queue at job database device 104-1. In one implementation, workflow engine device 106-1 may poll the active job queue to detect a newly queued job description. Workflow engine device 106-1 may request job database device 104-1 to remove the job description from the queue when the job and its subtasks are completed.

In driving/performing each of the subtasks of a job, workflow engine device 106-1 may employ VMM control device 106-2, network management device 106-3, and/or resource lifecycle management device 106-4. Each of the subtasks in the job description may entail allocation, de-allocation, controlling, and/or monitoring of virtual resources, physical resources, and/or network resources. For example, assume that user device 130 requests resource management device 104-3 to allocate a virtual machine. In response, resource management device 104-3 may create a job description that includes subtasks for creating a virtual machine, and place the job description at job database device 104-1. When workflow engine device 106-1 is about to perform the subtasks associated with creating the virtual machine, workflow engine device 106-1 may dispatch one or more requests for performing virtual machine-related functions to VMM control device 106-2 (e.g., a request to create the virtual machine, clone a virtual machine, etc.).

VMM control device 106-2, upon receiving requests from workflow engine device 106-1, may control and/or monitor one or more virtual machines by interacting with hypervisors. The term “hypervisor,” as used herein, may refer to a program that monitors, creates, runs, removes, and/or controls a virtual machine (e.g., controls a lifecycle of a virtual machine) on a physical device. For example, when VMM control device 106-2 receives a request to create a virtual machine from workflow engine device 106-1, VMM control device 106-2 may issue a command to a hypervisor. The hypervisor may create the virtual machine on the host device.

Network management device 106-3 may perform network configuration functions on behalf of workflow engine device 106-1. The functions may include configuring network infrastructure components. FIG. 1 shows a number of different types of network resources that network management device 106-3 may manage, such as, for example, a virtual load balancer 108-4, virtual LAN 108-5, and virtual firewall 108-6. Virtual load balancer 108-4, virtual LAN 108-5, and virtual firewall 108-6 are further described below.

Resource lifecycle management device 106-4 may perform subtasks for provisioning a physical hardware device for the user. For example, resource lifecycle management device 106-4 may install an operating system on a server, install an application, etc. As shown in FIG. 1, resource lifecycle management device 106-4 may act on physical server devices 112-1 through 112-3 as well as virtual machines 108-2, as described below.

Virtual system network 108 may include devices and/or components for hosting and implementing virtual machine-related and network component-related resources that may be provisioned for the user. As shown, these resources may include a hypervisor group 108-1, virtual machines 108-2, logical volume 108-3, virtual load balancer 108-4, virtual LAN 108-5, and virtual firewall 108-6.

Hypervisor group 108-1 may include a logical group of hypervisors and a hypervisor manager (not shown). When hypervisor group 108-1 receives a command or a request from VMM control device 106-2 (e.g., create a virtual machine), the hypervisor manager may issue a command/request to a hypervisor. The hypervisor may then create the virtual machine on a host device on which the hypervisor is installed. Depending on the implementation, the hypervisor may be hosted on a hardware device without an operating system, or alternatively, may be hosted as a software component running on an operating system.

Virtual machines 108-2 may include a software emulation of a computer system (e.g., a server, a personal computer, etc.). Each virtual machine 108-2 may be instantiated, removed, and managed by a hypervisor. Once created, user device 130 may utilize virtual machine 108-2 as if it were a physical device.

Logical volume 108-3 may include storage on a network (e.g., a NAS appliance, a disk on storage area network (SAN), etc.). Local volume 108-3 may be allocated as a resource by workflow engine device 106-1. Once allocated, logical volume 108-1 may be mounted on a mount point on a virtual machine and used as storage (e.g., a file system, swap space, etc.). In some instances, a provisioned NAS appliance may be mounted as a shared logical volume on the virtual machine. The NAS appliance may then be exported (e.g., mounted) on another device on network 100 (e.g., a device designated by the user).

Virtual load balancer 108-4 may include an emulation of a load balancer, and may be instantiated or removed upon demand from user device 130. The user may configure virtual load balancer 108-4 such that network traffic is distributed over the virtual and/or physical resources in accordance with specified thresholds (e.g., send 40% of network traffic to one of virtual machines 108-2 and 60% of network traffic to the other virtual machine).

Virtual LAN 108-5 may be created upon demand from user device 130. User device 130 may configure and place selected virtual and physical resources on specific virtual LAN 108-5. Virtual firewall 108-6 may include an emulation of a physical firewall, and may be instantiated or deleted upon demand from user device 130. Once provisioned, virtual firewall 108-6 may be attached to virtual LAN 108-5 to protect the virtual and/or physical resources against undesired network traffic.

Inventory management network 110 may track inventory of network resources and provide inventory information to resource management network 104. As further shown in FIG. 1, inventory management network 110 may include IP address management device 110-1, data warehouse device 110-2, and an inventory management device 110-3.

IP address management device 110-1 may provision an IP address from a pool of IP addresses. In one implementation, in provisioning an IP address, IP address management device 110-1 may take into account network address translation schemes to identify which VLAN the IP address belongs to, such that an IP address conflict does not arise within the VLAN. When IP address management device 110-1 de-provisions an IP address, IP address management device 110-1 may return the IP address to the pool of IP addresses.

Data warehouse device 110-2 may include a database of inventory of resources that are available for provisioning, resources that have been provisioned for the user, and configuration management information. When a resource is added to a pool, is provisioned, or is de-provisioned, data warehouse device 110-2 may update/record the information (e.g., inventory information) about the resource in the database. In addition, data warehouse device 110-2 may write and insert data associated with configuration (e.g., a version of an operating system that is installed on a provisioned physical server, an IP address, etc.) into the database when the resource configuration changes.

Inventory management device 110-3 may obtain inventory and configuration related information by monitoring physical devices, and pass the information to data warehouse device 110-2.

Physical resource network 112 may include physical resources. These physical resources may be provisioned/de-provisioned upon a request from resource lifecycle management device 106-4. When physical resources in physical resource network 112 are provisioned/de-provisioned, resource lifecycle management device 106-4 or inventory management device 110-3 may update data warehouse device 110-2 with information about the provisioning and configuration information.

As further shown in FIG. 1, physical resource network 112 may include physical resources 112-1 through 112-3 (individually referred to as physical resource 112 and collectively as physical resources 112), logical volume 112-4, and storage device 112-5. Physical resource 112 may include a physical device or a component that may be provisioned via resource lifecycle management device 106-4. Logical volume 112-4 may include similar component as logical volume 108-3, and may operate similarly. Unlike logical volume 108-3 that is mounted on a virtual machine, however, logical volume 112-3 may be mounted on physical resource 112. Storage device 112-5 may include storage from which logical volumes (e.g., logical volume 108-3 or 112-4) may be allocated. Examples of storage device 112-5 may include a SAN disk and NAS devices.

In FIG. 1, although each of networks 102 through 112 are shown as including a number of devices, in an actual implementation, networks 102 though 112 may include additional, fewer, or different devices and components than those shown in FIG. 1. In addition, depending on the implementation, functionalities of each of devices within networks 102-112 may be aggregated over fewer devices or distributed over additional devices. For example, in one implementation, functionalities of devices 112-1 through 112-3 in resource management network 112 may be provided by a single server device.

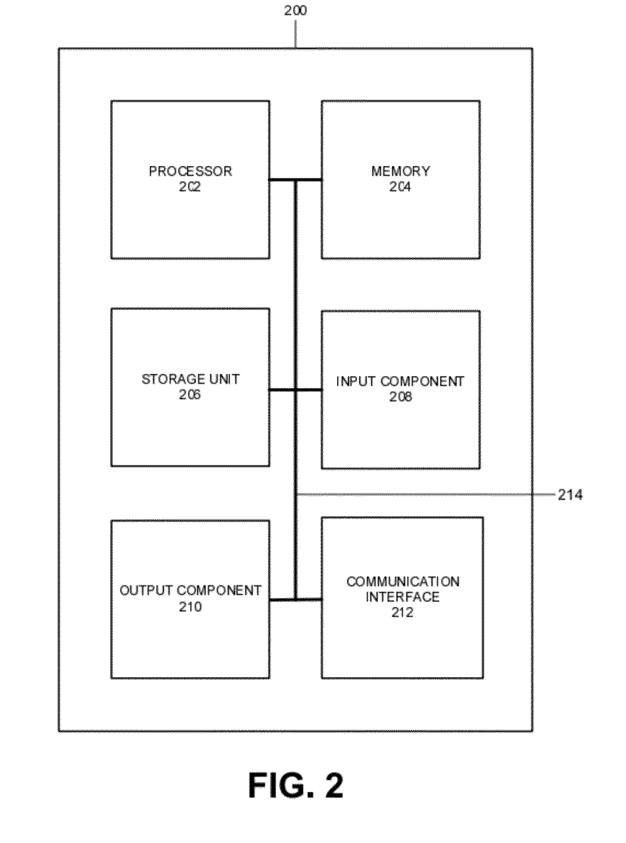

FIG. 2 is a block diagram of an exemplary network device 200. Network device 200 may be used to implement each of the devices in networks 102 through 112. In addition, network device 200 may also be used to implement components of a cluster. As shown in FIG. 2, network device 200 may include a processor 202, memory 204, storage unit 206, input component 208, output component 210, communication interface 212, and bus 214.

Processor 202 may include one or more processors, microprocessors, application specific integrated circuits (ASICs), field programmable gate arrays (FPGAs), or other processing logic that may interpret and execute instructions. Memory 204 may include static memory, such as read only memory (ROM), and/or dynamic memory, such as random access memory (RAM) or onboard cache, for storing data and machine-readable instructions. Storage unit 206 may include a magnetic and/or optical storage/recording medium. In some embodiments, storage unit 206 may be mounted under a directory tree or may be mapped to a drive. In some implementations, storage unit 206 may be part of another network device (e.g., storage device 112-5) or a network (e.g., storage area network (SAN)). Depending on the context, the term “medium,” “memory,” “storage,” “storage device,” “storage medium,” and/or “storage unit” may be used interchangeably. For example, a “computer-readable storage device” or “computer readable storage medium” may refer to both a memory and/or storage device.

Input component 208 may permit a user to input information to network device 200. Input component 208 may include, for example, a keyboard, a keypad, a mouse, a pen, a microphone, a touch screen, voice recognition and/or biometric mechanisms, etc. Output component 210 may include a mechanism that outputs information to the user. Output component 210 may include, for example, a display, a printer, a speaker, etc. In some implementations, because network device 200 may operate as a server device, network device 200 may include a minimal number of input components 208 and output components 210 (e.g., a keyboard and/or a console), to minimize cost and to increase robustness.

Communication interface 212 may enable network device 200 or the components of network device 200 to communicate with other devices and/or systems via a network, and may include one or more network interface cards (e.g., an Ethernet interface) for communicating with other devices. In one implementation, communication interface 212, for example, may be attached to a server blade that hosts processor 202. Bus 214 may provide an interface through which components of network device 200 can communicate with one another.

In FIG. 2, network device 200 is illustrated as including components 202-212 for simplicity and ease of understanding. In an actual implementation, network device 200 may include additional, fewer, or different components. For example, assuming that network device 200 is a virtual machine, components 202-212 may include virtual components. In another example, network device 200 may include one or more power supplies, fans, motherboards, video cards, etc. In yet another example, the components of network device 200 may be distributed over a network.

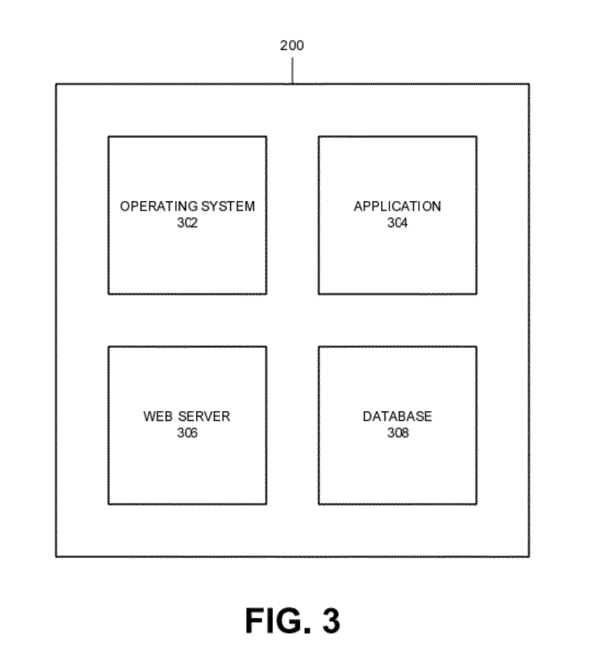

FIG. 3 is a block diagram illustrating exemplary functional components of network device 200. As shown, network device 200 may include an operating system 302, application 304, web server 306, and database 308. Depending on the implementation, network device 200 may include additional, fewer, or different components than those illustrated in FIG. 3.

Operating system 302 may manage hardware and software resources of network device 200. Operating system 302 may manage, for example, its file system, device drivers, communication resources (e.g., transmission control protocol (TCP)/IP stack), event notifications, etc.

Application 304 may include software program and/or scripts for rendering services. For example, in resource management device 104-3, application 304 may take the form of one or more programs for provisioning resources. Other examples of application 304 a file transfer protocol (FTP) server, an email server, a telnet server, servlets, Java™ virtual machine (JVM), web containers, C# programs, firewall, components to support Authorization, Authentication and Accounting (AAA), and other applications that either interact with client applications or operate in stand-alone mode. In addition, application 304 may include a specialized server program, application server, web page, etc.

Web server 306 may include a software application for exchanging web page related information with one or more browsers and/or client applications. Web server 306 may also provide support for other protocols, such as Simple Object Access Protocol (SOAP), for invoking object methods over a network. Database 308 may include records and files and may act as an information repository for network device 200. For example, in resource manager database 104-2, database 308 may store and retrieve configuration/usage data pertaining to a particular user. In another example, database 308 in job database device 104-1 may implement persistent queues for storing job descriptions. In such implementations, the queue may be robust and, therefore, recoverable upon device failure.

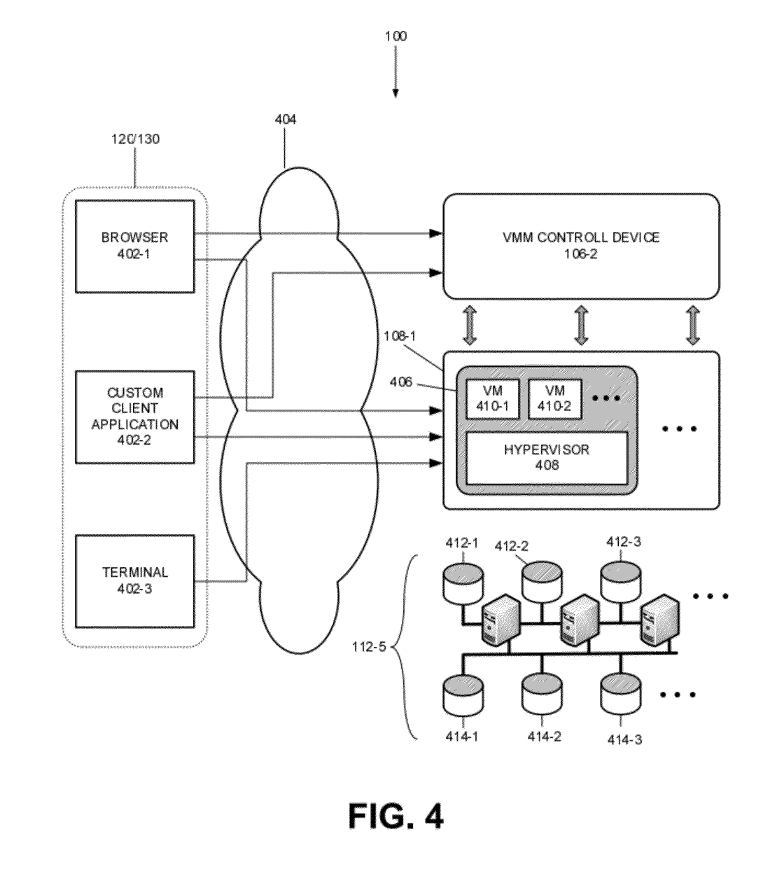

FIG. 4 illustrates interaction between administrator/user device 120/130, VMM control device 106-2, hypervisor group 108-1, and storage device 112-5 for provisioning and/or managing NAS appliances. The provisioning may be part of another process, for example, for provisioning a NAS appliance, a cluster, etc. Network 404 may be part of network 100, and may include network or network devices, such as user portal device 102-2, resource management device 104-3, etc.

As further shown in FIG. 4, administrator/user device 120/130 may host different types of client applications, such as a browser 402-1, custom client application 402-2, and/or terminal 402-3 (e.g., xterm). Browser 402-1 may include a web browser (e.g., Internet Explorer, Firefox, Safari, etc.). Custom client application 402-2 may include a software component specifically designed for interacting with VMM control device 106-2 and/or hypervisor group 108-1 via different communication paths. Terminal 402-3 may include a command line interface based client terminal for remotely accessing different services, such as telnet services, SFTP services, etc.

As further shown in FIG. 4, VMM control device 106-2 may interact with hypervisor group 108-1. Hypervisor group 108-1 may include a hypervisor manager (not shown) and one or more hypervisor devices 406. In hypervisor group 108-1, the hypervisor manager may administer/control hypervisor devices 406.

Each hypervisor device 406 may include a hypervisor 408 and virtual machines 410-1 and 410-2. Although FIG. 4 shows two virtual machines 410-1 and 410-2, in an actual implementation, hypervisor device 406 may include fewer or additional virtual machines that are instantiated and monitored by hypervisor 408.

For storage, each hypervisor device 408 may access logical volumes. As shown in FIG. 4, the logical volumes may be implemented via storage device 112-5. In one implementation, storage device 112-5 may include SAN disks 412-1, 412-2, 412-3, etc., and NAS devices/appliances 414-1, 414-2, 414-3, etc.

In FIG. 4, administrator/user device 120/130 may control, monitor, provision, or de-provision NAS appliances to a user via browser 402-1. For example, through different devices (e.g., user portal device 102-2), a user's request for a service may reach devices in network 100 to provision NAS appliances 414. In addition, VMM control device 106-2 may then perform a set of functions for provisioning a virtual machine on which the NAS appliances are to be mounted and made available to network 100 as shared volumes.

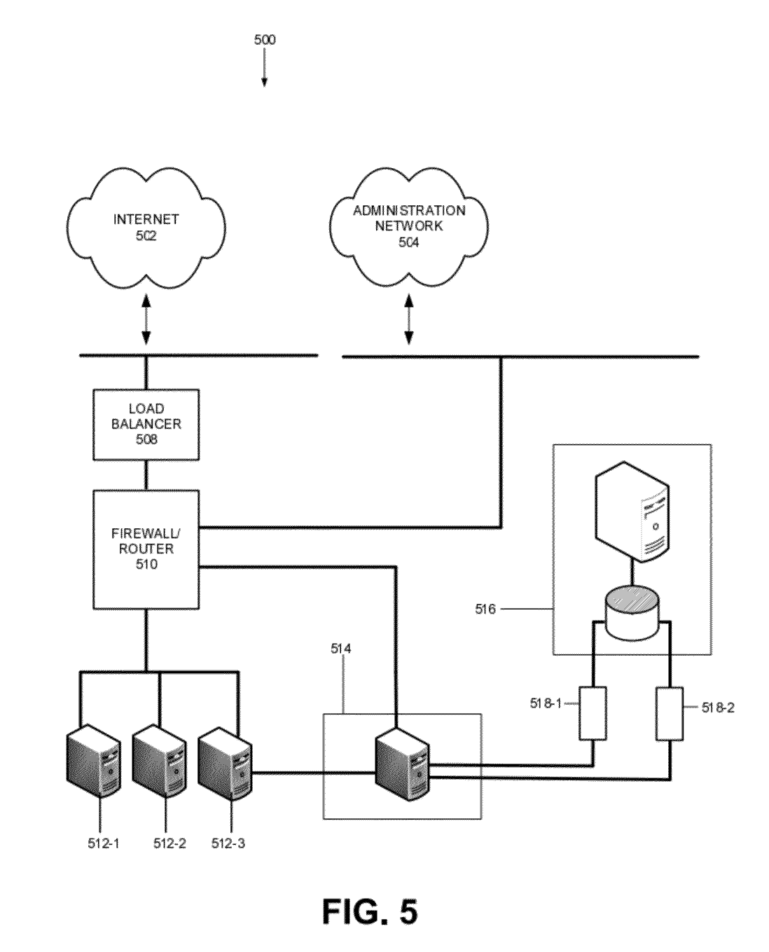

FIG. 5 illustrates provisioning an exemplary NAS appliance 516 via a virtual machine 514. In a different implementation, NAS appliance 516 may be provisioned via a physical server. As shown in FIG. 5, system 500 may provision a user with connectivity to the Internet 502, administration network 504, load balancer 508, firewall/router 510, physical/virtual servers 512-1 through 512-3, virtual machine 514, NAS appliance 516, and fiber channels 518-1 and 518-2.

Administration network 504 may provide services such as a backup service, security service, billing, etc. Load balancer 508 may balance network traffic over different devices (e.g., load balance between servers 512-1 through 512-3). Firewall/router 510 may safeguard servers 512-1 through 512-3 and virtual machine/server 514 from outside networks via enforcement of firewall security rules and/or network address translation (NAT). Servers 512-1 through 512-3 may host applications.

Virtual machine/server 514 may provide one or more mount points for NAS appliances. In one implementation, virtual machine/server 514 may run different file server programs, such as, for example, Samba. Another server, such as server 512-3, may mount NAS appliance via virtual server 514 (e.g.., Network File system (NFS) or Common Internet File System (CIFS) as a Unix-like file system or a drive.

NAS appliance 516 may include storage devices, which may be accessed by virtual machine/server 514 via one of two channels 518-1 and 518-2. Channels 518-1 and 518-2 are provided for redundancy, for example, in case of a fiber channel failure.

In FIG. 5, when a user requests a NAS appliance to be provisioned, devices in system 500 may provision virtual server/machine 514, provision NAS appliance 516, and serve NAS appliance 516 on virtual server/machine 514. Once NAS appliance 516 is provisioned via virtual server/machine 514, the user may use NAS appliance 516. For example, in FIG. 5, the user may mount NAS appliance 516 on server 512-3 via via virtual server/machine 514.

FIG. 6 is a list of exemplary resources and functions that one or more devices of FIG. 1 may support for provisioning resources. The devices in networks 102-112 may invoke functions 604-1 through 606-4 on resources 602-1 through 602-10. For example, when a resource management device 104-3 receives, from user device 130, a service request to provision a virtual server, resource management device 104-3 may create a virtual machine 602-4 via VMM control device 106-2 in hypervisor group 108-1, as illustrated in FIG. 4.

As further shown in FIG. 6, resources 602 may include virtual center 602-1, data center 602-2, resource pool 602-3, virtual machine 602-4, hypervisor 602-5, cluster 602-6, storage volume 602-7, application 602-8, network 602-9, and server 602-10 Virtual center 602-1 may include a collection of hypervisors 408 that are controlled or monitored by a hypervisor manager. Data center 602-2 may include a logical grouping of hypervisors. Resource pool 602-3 may include a group of hypervisor devices that aggregate CPU and/or memory capacity to be allocated to virtual machines on demand. Virtual machine 602-4 may include a software emulation of a computer system. Hypervisor 602-5 may include a program that monitors, creates, runs, removes, and/or controls a virtual machine. Cluster 602-6 may include at least one standby device and active devices. The standby device may become active when one of the active devices fail, such that the cluster may continue to operate normally (e.g., provide services to clients).

Storage volume 602-7 may include a storage unit of given size. Storage volume 602-7 may include a logical volume, such as a NAS appliance or a SAN device. Application 602-8 may include a client program, server program, script, and/or another type of executable software component. Network 602-9 may include a portion of networks 110 and 112. The portion may be provisioned to a user at user device 130. Server 602-10 may include a virtual server (e.g., a virtual machine) or a physical server.

Functions 604 may include list objects function 604-1 and show object function 604-2. List objects function may request VMM control device 106-2 to provide a list of resources 602. For example, administrator device 120 may request VMM control device 106-2 to list virtual center 602-1. When VMM control device 106-2 receives the request, VMM control device 106-2 may provide a list of names of virtual centers within network 100. Show object function 604-2 may request VMM control device 106-2 to provide details that are related to resource 602. For example, administrator device 120 may request VMM control device 106-2 to show a particular virtual center 602-1. In response to the request, VMM control device 106-2 may provide a version number of the hypervisor manager.

Show functions 606 may include show CPU 606-1, show NIC 606-2, show memory 606-3, and show disk 606-4. Show functions 606-1 through 606-4 may show a CPU usage, network usage, memory usage, and disk usage of a device/cluster, respectively.

FIG. 7 is a list of exemplary functions that one or more devices of FIG. 1 may support for provisioning resources. The devices in networks 102-112 may invoke functions 702-1 through 702- on resources 602-1 through 602-10. For example, when user device 130 makes a service request to provision a NAS appliance, resource management device 104-3 may execute function 702-2, which is described below. This may generate a job description for provisioning a NAS appliance, hand off the job description to job database device 104-1, etc.

As shown, NAS-related allocation functions 702 may include create VM 702-1 and provision/de-provision NAS appliance 702-2/702-3, NAS share 702-4/702-5, and NAS mount 702-6/702-7. In requesting create VM 702-1, a user/device may specify parameters for a virtual machine to be provisioned, such as the amount of memory for the virtual machine, number of CPUs to be used for the virtual machine, the name of the virtual machine, etc.

Provision NAS appliance 702-2 may provision a NAS appliance (e.g., format a NAS device), create/provision a physical/virtual server/machine, mount the NAS appliance as a shared volume on the virtual/physical server, and export the volume via a network file server program. De-provision NAS appliance 702-3 may remove the provisioned NAS appliance from the network (e.g., return the NAS appliance to a resource pool, de-provision the physical/virtual server, etc.). Provision NAS share 702-4 may export a NAS appliance that is mounted on a provisioned physical/virtual server (e.g., convert a NAS appliance volume into a shared volume). De-provision NAS share 702-5 may convert a shared NAS appliance volume into a non-shared volume. Provision NAS mount 702-6 may mount the NAS appliance at the provisioned virtual machine onto a host/server designated by the user. De-provision NAS mount 702-7 may un-mount the NAS appliance that is mounted on the host/server.

In FIGS. 6 and 7, resources 602-1 through 602-10, functions 604-1 through 606-4, and functions 702-1 through 702-7 are illustrated for simplicity. Depending on the implementation, networks 102-112 may include and/or support additional, fewer, or different types of resources and functions. For example, other types of resources may include machine access control (MAC) addresses and IP addresses.

In tracking, managing, provisioning, and/or de-provisioning one or more resources 602 in networks 102-112, resource management device 104-3 may instantiate, use, and/or de-allocate objects that represent resources 602 and resource types. Such objects may correspond to different entries/records in databases in networks 102-112.

For example, assume that user device 130 requests a NAS appliance to be provisioned. In response, resource management device 104-3 may provision a NAS, instantiate a NAS appliance object that corresponds to the NAS appliance its memory 204, and create a database record for the NAS appliance. When user device 130 issues a service request with respect to the NAS appliance object, resource management device 104-3 may generate a job or task with respect to the NAS appliance in networks 102-112. Resource management device 104-3 may update the NAS appliance object periodically, upon receiving a notification of a change to the state of the NAS object in networks 102-112, and/or upon being prompted by administrator/user device 120/130.

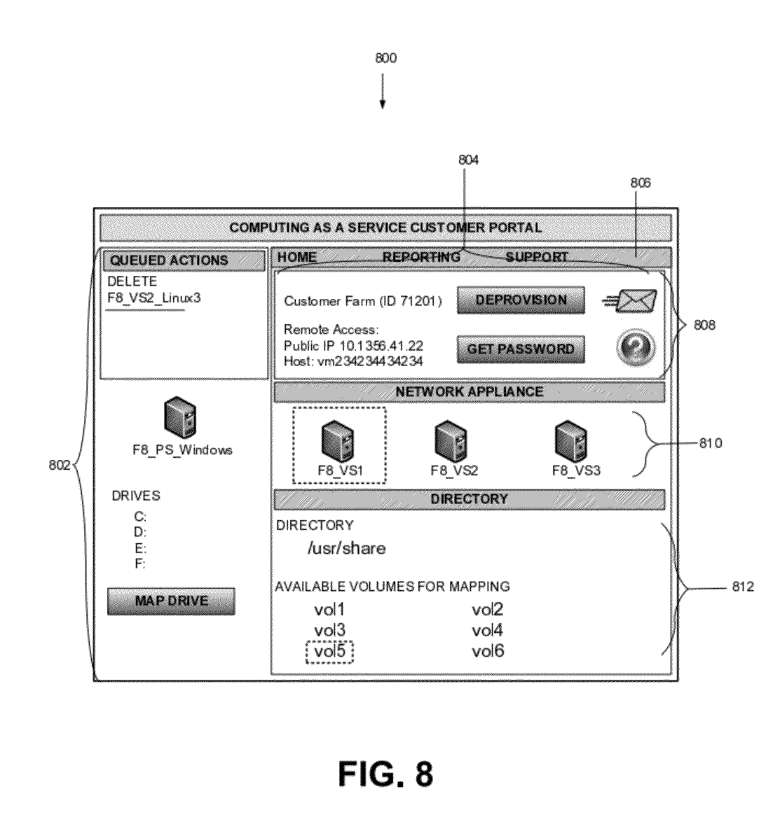

FIG. 8 illustrates a view 800 of an exemplary web-based user interface for provisioning a NAS appliance. More specifically, view 800 shows a web page for provisioning NAS appliance mounted on servers (e.g., virtual/physical). Some features of a typical web browser, such as a navigation bar, etc., are not illustrated for simplicity.

As shown, the web page may include a side pane 802 and a main pane 804. Side pane 802 may include a list of jobs that are pending (e.g., deleting an operating system on a server) and a server on which a drive is to be mapped to a NAS appliance. Main pane 804 may include menu bar 806, shortcut buttons 808, server display 810, and NAS appliance volume display 812. Menu bar 806 may provide links to other web pages, such as “Home,” “Reporting,” or “Support” pages. Shortcut buttons 808 include buttons for executing commands “de-provision” or “get password.” Server display 810 may illustrate servers that are currently accessible or have been provisioned. Each of the servers may include one or more NAS appliances that may be mounted on the server shown in side pane 802. A user may select one of the servers on server display 810. In FIG. 8, the selected server is shown inside a dotted, rectangular box. NAS appliance volume display 812 may display a list of mountable NAS appliances (shown as volumes). A user may select one of the NAS appliance volumes (e.g., vol5 in FIG. 8) to be mounted on the server shown on side pane 802, by clicking (e.g., via a mouse) on “MAP DRIVE” button to provision the NAS appliance. Depending on the implementation, the web page may include additional, fewer, or different features than those shown in FIG. 8, such as a selection button or a menu item for requesting a NAS appliance provisioning.

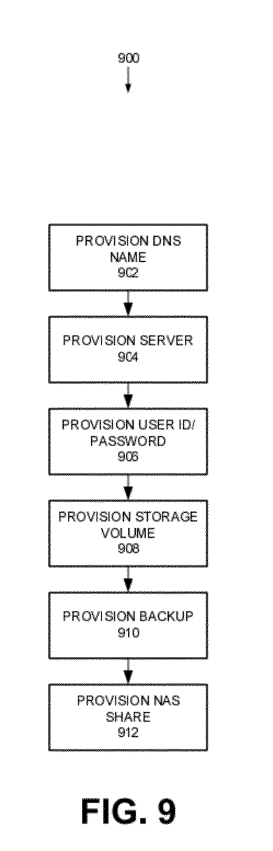

FIG. 9 is a flow diagram of an exemplary process 900 that is associated with provisioning a NAS appliance. Assume that administrator/user device 120/130 has sent a request to resource management device 104-3 to provision a NAS appliance via a virtual/physical server. In response, resource management device 104-3 may submit jobs/tasks, to job database device 104-1, to provision the requested resource. Workflow engine device 106-1 may drive the performance of each of the submitted jobs and de-queue the performed jobs from jobs database device 104-1.

Workflow engine device 106-1 may provision a DNS name (block 902). Depending on the implementation, the DNS name may be selected or chosen by a user or by resource management device 104-3/workflow engine device 106-1. In provisioning the DNS name, workflow engine device 106-1 may register the DNS name and a corresponding IP address (e.g., obtained from IP address management device 110-1) with a DNS server.

Workflow engine device 106-1 may provision a server (block 904). Depending on the implementation and/or user input, the workflow engine device 106-1 may provision a physical device or a virtual server, with the DNS name registered at block 902. As explained above, workflow engine device 106-1 may provision the virtual server via VMM control device 106-2 or a physical server via resource lifecycle management device 106-4. The provisioned server may include a processor (e.g., a virtual processor), a memory, storage, an operating system (e.g., SUSE Linux), an application (e.g., Samba), etc.

Workflow engine device 106-1 may provision a storage volume/NAS appliance (block 908). Provisioning the storage volume/NAS appliance may include receiving none, one, or more parameters from a user (e.g., volume size), creating a physical volume, creating a logical volume from the physical volume, mounting the logical volume on the server provisioned at block 904 or creating a drive, recording the mounted volume (e.g., /etc/fstab in UNIX). In some implementations, workflow engine device 106-1 may provision a disk mirroring for the NAS appliance.

Workflow engine device 106-1 may provision a backup for the storage volume (block 910). Provisioning a backup for the storage volume/NAS appliance may include designating, at a backup device/application, the server and logical volumes to be backed up and directories to be excluded from being backed up. A user may modify the backup configuration (e.g., cause the NAS appliance to be backed up by performing a backup of a server that shares the NAS appliance, set a time at which the backup occurs, etc.).

Workflow engine device 106-1 may provision the NAS appliance as a shared device (block 912). In one implementation, for example, this may include exporting the NAS appliance as a Common Internet File System (CIFS) (e.g., via Samba), run a network file system (NFS), etc. A user may mount the shared NAS appliance or assign it to a drive.

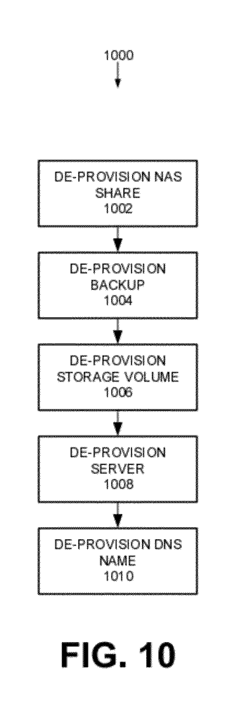

FIG. 10 is a flow diagram of an exemplary process that is associated with de-provisioning a NAS appliance. As shown, process 1000 may begin with de-provisioning a NAS share (block 1002). This may include un-mounting the logical volume representing the NAS share from a host, removing the name of the logical volume from a system file on the host, stop running NFS and/or Samba, etc.

Workflow engine device 106-1 may de-provision a backup associated with the NAS appliance (block 1004). This may include removing the backup paths from a backup device/application. As a result of the de-provisioning, the backup device may no longer create a backup of the NAS appliance or the corresponding logical volume.

Workflow engine device 106-1 may de-provision the storage volume corresponding to the NAS appliance (block 1006). The de-provisioning may include un-mounting the NAS appliance from a host, un-mounting the NAS appliance from the server provisioned at block 904, removing the logical volume corresponding to the NAS appliance, removing the physical volume from which the logial volume has been created, etc. This may also include removing any mirroring that may have been performed in process 900.

Workflow engine device 106-1 may de-provision a server that is provisioned at block 904 (block 1008). For example, workflow engine device 106-1 may de-provision a physical server or a virtual server (e.g., delete the virtual sever) via which the NAS appliance was made available to network devices for sharing. De-provisioning the server may include de-provisioning other types of resources that were provisioned in order to provision the server.

Workflow engine device 106-1 may de-provision the DNS name provisioned at block 902. This may include un-registering the DNS name from the DNS server (e.g., removing the name from the DNS server), returning the corresponding IP address to IP address management device 110-1, etc.

In the foregoing description, networks 102-112 may provision both virtual resources and physical resources. When a user wishes to obtain computing resources (e.g., a network, a server, an application, a web server, a cluster, etc.), the user may connect to an integrated provisioning system via a web portal. Once connected via a web interface, the user may input parameters that describe the desired resources. Based on the parameters, the integrated resource provisioning system may provision and allocate virtual and/or physical resources with or without manual intervention from a system administrator or an operator.

In some implementations, network 100 may provision a NAS appliance via a virtual machine/physical device. In provisioning the NAS appliance, network 100 receive parameters (e.g., size of the storage space on the NAS appliance) from a user, provision a virtual machine/physical server, and provision the NAS appliances mounted on the virtual machine/physical device. Upon the provisioning of the NAS appliance, the user may mount the NAS appliance on one or more hosts/server devices and use the NAS appliance for storage.

The foregoing description of exemplary implementations provides illustration and description, but is not intended to be exhaustive or to limit the embodiments described herein to the precise form disclosed. Modifications and variations are possible in light of the above teachings or may be acquired from practice of the embodiments.

Further, while series of acts have been described with respect to FIGS. 9 and 10, the order of the acts may be varied in other implementations. Moreover, non-dependent acts may be implemented in parallel. Furthermore, in other implementations, processes 900 and 1000 may include additional, fewer, or different acts than the ones illustrated in and discussed with references to FIGS. 9 and 10.

It will also be apparent that various features described above may be implemented in many different forms of software, firmware, and hardware in the implementations illustrated in the figures. The actual software code or specialized control hardware used to implement the various features is not limiting. Thus, the operation and behavior of the features of the invention were described without reference to the specific software code—it being understood that one would be able to design software and control hardware to implement the various features based on the description herein.

Further, certain features described above may be implemented as “logic” that performs one or more functions. This logic may include hardware, such as one or more processors, microprocessors, application specific integrated circuits, or field programmable gate arrays, software, or a combination of hardware and software.

In the preceding specification, various preferred embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

No element, act, or instruction used in the description of the present application should be construed as critical or essential to the invention unless explicitly described as such. Also, as used herein, the article “a” is intended to include one or more items. Further, the phrase “based on” is intended to mean “based, at least in part, on” unless explicitly stated otherwise.

What is claimed is:

1. A method comprising:
receiving a user request for provisioning a network attached storage over a network;
provisioning a server with a domain name in response to the user request;
configuring the server with a user identifier and a password, for gaining authorized access to the server;
creating a logical volume;
mounting the logical volume on the server; and
exporting the logical volume as a shared volume.

2. The method of claim 1, further comprising:
mounting the logical volume; and
recording the mounting of the logical volume by modifying a system file on the server.

3. The method of claim 1, wherein the exporting the logical volume includes:
executing network file system (NFS); or
executing Samba for Common Internet File System (CIFS).

4. The method of claim 1, further comprising:
mounting the exported volume on a host device.

5. The method of claim 1, further comprising:
configuring a mirror for the logical volume; or
configuring a backup device for automatic backup of the logical volume.

6. The method of claim 1, wherein provisioning the server includes:
provisioning a virtual machine; or
provisioning a physical device.

7. The method of claim 6, wherein provisioning the virtual machine includes:
creating a virtual central processing unit;
a memory; and
storage space.

8. The method of claim 6, wherein provisioning the virtual machine includes:
obtaining an Internet Protocol (IP) address from a pool of IP addresses;
registering the domain name and the IP address with a domain name server.

9. The method of claim 8, further comprising:
receiving, over the network, a user request to de-provision the virtual machine; and
deleting the virtual machine in response to the user request over the network.

10. The method of claim 9, further comprising:
returning the IP address to the pool; and
de-provisioning the logical volume.

11. A system comprising:
a resource management device to:
receive a web request for provisioning a network attached storage over a network, and
insert a job in a queue, the job corresponding to the request for provisioning; and
a workflow engine device to:
provision a server in accordance with the job;
create a logical volume from physical devices;
mount the logical volume on the server;
export the logical volume as a shared volume; and
remove the job from the queue.

12. The system of claim 11, wherein the server includes one of:
a physical server or a virtual machine.

13. The system of claim 11, wherein the workflow engine is further configured to:
record the mounting of the logical volume on a system file.

14. The system of claim 11, wherein the server is configured to:
execute network file system (NFS); or
execute a program to export Common Internet File System (CIFS).

15. The system of claim 11, further comprising:
a host device, configured to:
mount the shared volume; or
map the shared volume to a drive.

16. The system of claim 11, wherein the workflow engine is further configured to:
configure a backup device for the logical volume.

17. The system of claim 16, wherein the workflow engine is further configured to:
add an exclusion path for the backup of the logical volume.

18. The system of claim 11, further comprising:
a domain name server; and
a Internet Protocol (IP) address management device to allocate an IP address for the server,
wherein the workflow engine is further configure to register a domain name and the IP address at the domain name server.

19. One or more computer readable media, comprising machine executable instructions, the instructions causing one or more processors to:
receive a request from a browser to provision a network attached storage;
provision a domain name and an Internet Protocol (IP) address;
register the domain name and the IP address at a domain name server;
create a virtual server with the domain name;
create a logical volume;
mount the logical volume on the virtual server; and
cause the virtual server to export the logical volume as a shared volume.

20. The one or more computer-readable media of claim 19, further comprising instructions for causing the one or more processors to mount the shared volume on a host device.
